(19) United States
(12) Patent Application Publication
(10) Pub. No.: US 2005/0191921 A1
(43) Pub. Date: Sep. 1, 2005

(54) Multidensity liner/insulator having reinforcing ribs

(76) Inventors: Jeffrey A. Tilton, Prospect, KY (US); Anthony L. Rockwell, Pickerington, OH (US)

Correspondence Address: OWENS CORNING, 2790 COLUMBUS ROAD, GRANVILLE, OH, 43023, US

(21) Appl. No.: 10/789,144

(22) Filed: Feb. 27, 2004

(51) Int. Cl. B32B 5/08

(52) U.S. Cl. 442/120; 442/60; 442/64; 442/86; 442/180; 442/164; 442/334; 442/335; 442/361; 442/362; 442/378; 442/381; 156/273.7; 156/311

(57) ABSTRACT

A liner/insulator including a base layer of fibrous material and a plurality of ribs of fibrous insulation material thermally bonded to said base layer. The fibrous material is constructed of either (a) thermoplastic polymer staple fibers and thermoplastic bicomponent fibers, (b) glass staple fibers and thermoplastic bicomponent fibers and (c) a combination of (a) and (b).

### RELATED APPLICATIONS

This application is related to U.S. Pat. No. 6,669,265 and U.S. patent application Ser. No. 10/749,084 filed Dec. 30, 2003 both of which are herein incorporated by reference in their entirety.

### TECHNICAL FIELD AND INDUSTRIAL APPLICABILITY OF THE INVENTION

The present invention relates generally to a polymer-based acoustical and thermal liner/insulator having reinforcing ribs, which provide strength to the product. The liner/insulator may be utilized as an undercarpet, headliner, or hoodliner of a vehicle to insulate the vehicle environment from the heat and sound generated by mechanical components of that vehicle during its operation. Further uses include application in insulating appliances such as dishwashers and clothes dryers and providing sound and thermal insulation for furnaces, air conditioning units and ductwork in buildings including homes, offices, commercial interiors and industrial structures.

### BACKGROUND OF THE INVENTION

Acoustical insulation is well known in the art. Acoustical insulation typically relies upon both sound absorption, i.e. the ability to absorb incident sound waves, and transmission loss, i.e. the ability to reflect incident sound waves, in order to provide sound attenuation. One of the more prevalent uses of such insulation is in the motorized vehicle field where engine compartments, fire walls, fender wells, doors, floor pans and other components of the passenger compartment shell are commonly acoustically insulated to reduce engine and road noise for the benefit and comfort of passengers.

Mats of high temperature glass fibers have also been utilized, e.g. (a) on the fire wall between the dashboard and engine compartment and (b) along the floor pan of the vehicle between the passenger compartment and the drive line and exhaust system. These materials provide heat insulation which makes it possible to maintain cooler and more comfortable temperatures in the operator/passenger compartment particularly during the summer months. Additionally, these materials provide needed sound insulation, reducing or eliminating various mechanical sounds of the motor, drive train as well as the suspension and tires as the vehicle travels over the often rough and bumpy surface of the roadway.

U.S. Pat. No. 4,474,846 discloses a moldable fibrous mat molded by applying heat and pressure to the mat. A web of mat material passes through a pair of crimping rolls having parallel ribs which may extend either axially or circumferentially. The ribs impress a pattern of grooves or indentations on the web to further increase the flexibility of the web permitting it to be bent or flexed to a great degree without breaking.

U.S. Pat. No. 5,660,908 discloses a high strength automotive headliner. The headliner is constituted by a polymeric fiber batt having a plurality of impressions in the form of corrugations or reverse ribs. The ribs include a plurality of corrugation channels between the corrugation ribs. Between the corrugations and the batt front side are areas of reduced batt thickness having a higher fiber density which acts as reinforcing elements to stiffen the headliner.

U.S. Pat. No. 4,741,945 discloses an automotive headliner constructed of a thermoplastic polymer foam core interposed between sheets of films made of the same or different thermoplastic polymers. The headliner further includes dead, vibration damping foam material in contact with the foam core. The vibration damping foam material is a closed-cell, low air permeability foam, preferably a urethane foam material.

U.S. Pat. No. 5,591,289 discloses a fibrous headliner foamed with a nonwoven high loft batting of thermoplastic fibers having a low percentage of binder fibers which are activated with heat to establish and hold the desired appearance side contour of the headliner. The batting is needled on both sides to form fibrous skin layers wherein the roof side layer is thicker and denser than the passenger compartment side skin layer. The high density skin layer is coated with a thermoset resin after the batting has been heated to activate the binder fibers.

U.S. Pat. No. 4,420,526 discloses a panel for sound insulation of vehicles constructed of a fabric of autogenously and chemically bonded, matter polyester fibers having fine surface pores. The fine surface pores have a positive effect on sound absorptivity.

U.S. Pat. No. 3,748,214 discloses a laminate used as a packaging material. The laminate includes two surfaces of thermoplastic resin which are heat bonded. One surface of the laminate contains ribs together having one surface containing ribs. At least one surface of the thermoplastic resin is heated sufficiently so that it bonds to the other surface. The final product comprises a film having channels in between the ribs.

None of the above prior art teaches a polymer fiber insulation base layer having multiple reinforcing ribs constructed of polymer fiber insulation material. The ribs being affixed to the insulation base layer by bonding with heat and pressure.

### SUMMARY OF THE INVENTION

In accordance with the purposes of the present invention as described herein, an improved acoustical and thermal liner/insulator of enhanced performance characteristics is provided.

The liner/insulator includes a base layer of fibrous material and a plurality of ribs of fibrous insulation material thermally bonded to said base layer. The ribs may be composed of the same material as the base layer or may be composed of different fibers blends of thermally bonded polymer fiber material. The ribs in combination with the base layer provide a product having improved compressive and flexural properties over a product simply having a base layer.

Preferably, the fibrous material of the liner/insulator is base layer and ribs is a polymeric material selected from a group consisting of polyester, polyethylene, polypropylene, polyethylene terephthalate, glass fibers, natural fibers and any mixtures thereof. The fibrous material of the base layer and/or the ribs may be selected from the group consisting of (a) thermoplastic polymer staple fibers and thermoplastic bicomponent fibers, (b) glass staple fibers and thermoplastic bicomponent fibers and (c) a combination of (a) and (b).

The ribs of the liner/insulator are preferably between about 0.5 to about 3.0 inches wide and are spaced apart from one another at least about 0.25 inches and can extend either parallel, perpendicular or diagonal to one another.

The liner/insulator may optionally contain a facing material on one or both sides of the liner/insulator. Such facing materials provide additional strength, water barrier properties and/or can improve the surface appearance of the product.

To reduce manufacturing costs, the liner/insulator may be produced in an “in line” process specifically if the base layer and ribs are made of the same materials. Or, alternatively, the ribs of the liner/insulator may be produced from scrap material.

It is an object of the present invention to provide a liner/insulator which has improved compressive strength.

It is a further object of the present invention to provide a liner/insulator which may be manufactured at a lower cost than previous materials.

Still other objects of the present invention will become apparent to those skilled in this art from the following description wherein there is shown and described preferred embodiments of this invention, simply by way of illustration of several of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawing incorporated in and forming a part of the specification, illustrates several aspects of the present invention and together with the description serves to explain the principles of the invention. In the drawing:

FIG. 1 is a cross-sectional view of a liner/insulator of the present invention.

FIG. 2 is cross-sectional view of another embodiment of the present invention.

FIG. 3 is an top elevational view of the liner/insulator of the present invention.

FIG. 4 is a perspective view of an alternative, cubed, fibrous material used as the ribs of the present invention.

FIG. 5 is a cross-sectional view of the liner/insulator including a relatively higher density skin along one face.

Reference will now be made in detail to the present preferred embodiments of the invention, examples of which are illustrated in the accompanying drawings.

### DETAILED DESCRIPTION AND PREFERRED EMBODIMENTS OF THE INVENTION

Reference is now made to FIG. 1, which illustrates a first embodiment of the liner/insulator of the present invention generally designated by reference numeral 2. The liner/insulator 2 includes a base layer 4 of fibrous material. The fibrous material of the base layer 4 may take the form of polymer fibers including but not limited to polyester, polyethylene, polypropylene, polyethylene terephthalate and any mixtures thereof. The fibrous material of the base layer 4 may also include (a) thermoplastic polymer staple fibers and thermoplastic bicomponent fibers, (b) glass staple fibers and thermoplastic bicomponent fibers and (c) a combination of (a) and (b). The thermoplastic staple fibers and bicomponent fibers may be selected from a group of materials including but not limited to polyester, polyethylene, polypropylene, polyethylene terephthalate and any mixtures thereof. The glass fibers may include E-glass, S-glass or basalt fibers. Natural fibers (e.g. hemp, kenaf) may also be included.

Fibrous ribs 6 are affixed to the base layer 4 via heat and pressure which is further discussed below. The fibrous material of the ribs 6 may take the form of polymer fibers including but not limited to polyester, polyethylene, polypropylene, polyethylene terephthalate and any mixtures thereof. As with the base layer 4, the fibrous material of the ribs 6 may also include of (a) thermoplastic polymer staple fibers and thermoplastic bicomponent fibers, (b) glass staple fibers and glass bicomponent fibers and (c) glass staple fibers and thermoplastic bicomponent fibers and (d) a combination of (a), (b) and (c).

The thermoplastic staple fibers and bicomponent fibers may be selected from a group of materials including but not limited to polyester, polyethylene, polypropylene, polyethylene terephthalate and any mixtures thereof. The glass fibers may include E-glass, S-glass or basalt fibers. Natural fibers (e.g. hemp, kenaf) may also be included.

The base layer 4 and ribs 6 of the liner/insulator 2 may be made of the same materials or, alternatively, may be constructed of different materials. For example, the base layer 4 may be made of polymeric fibrous material and, in the alternative, the ribs may be made of a combination of glass staple fibers and thermoplastic bicomponent fibers and other combinations as outlined above.

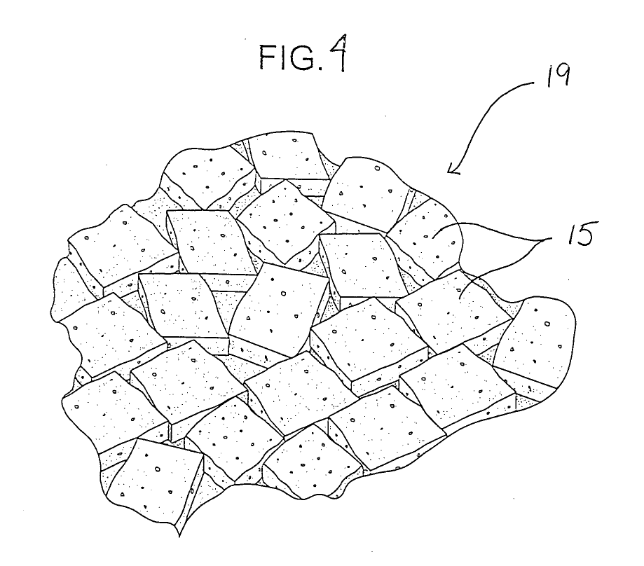

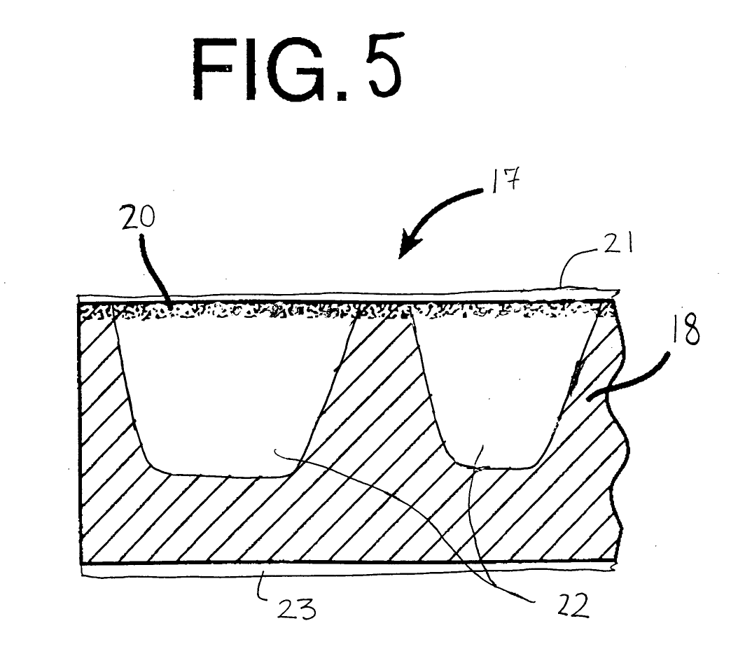

As shown in FIGS. 1 and 4, the ribs 6 and 16 extend parallel to one another. The ribs 6 provide strength to the base layer 4.

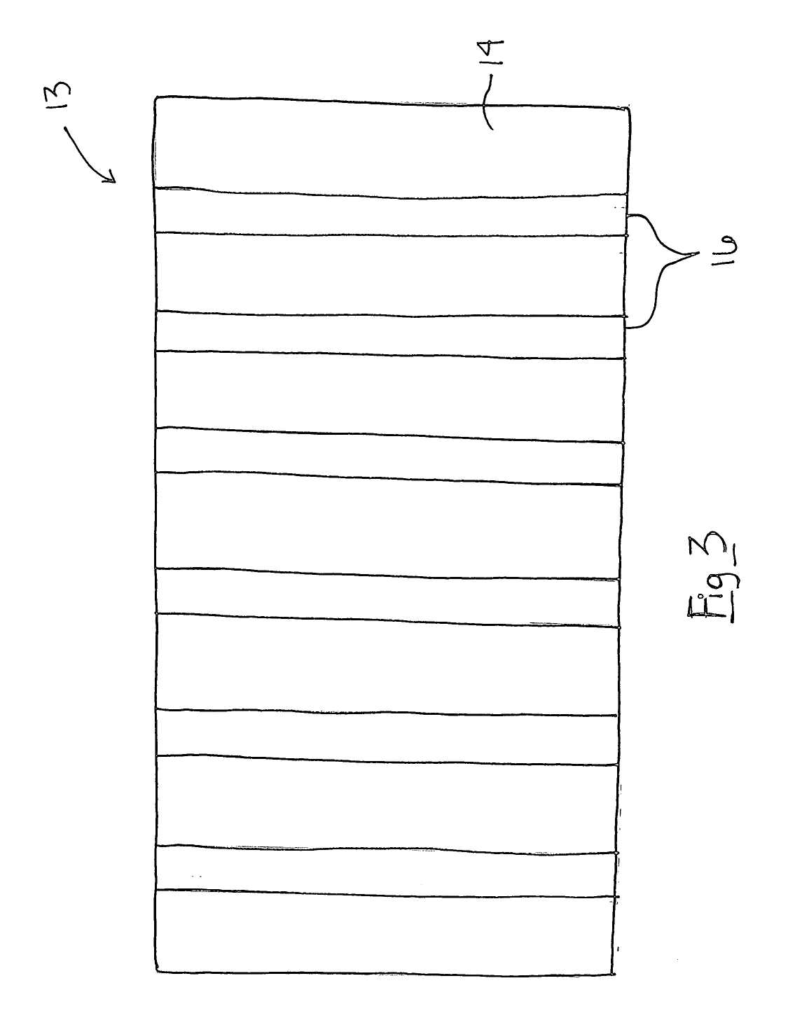

Alternatively, the ribs 6 may be laid on the base layer 4 diagonal or perpendicular to one another (not shown). The ribs 6 may also be laid on the base layer in waves (not shown). The ribs 6 may be spaced evenly across the base layer 4 or may be grouped together, i.e., in sets. Spacing of the ribs 6 or groups of ribs can vary, preferably the ribs, or groups of ribs, are spaced 0.25 inches apart or more. Ribs 16 extend laterally across the base layer 14, as shown in the liner/insulator 13 of FIG. 3. It may be preferable for the ribs 16 to extend across the base layer 14 longitudinally, depending on the strength desired in the end product.

Acoustical benefits can also be gained by the positioning of the ribs on the base layer, i.e., the ribs are manufactured and laid on the base layer to provide the majority of the strength in the liner/insulator while the base layer is tuned to provide maximum acoustical properties.

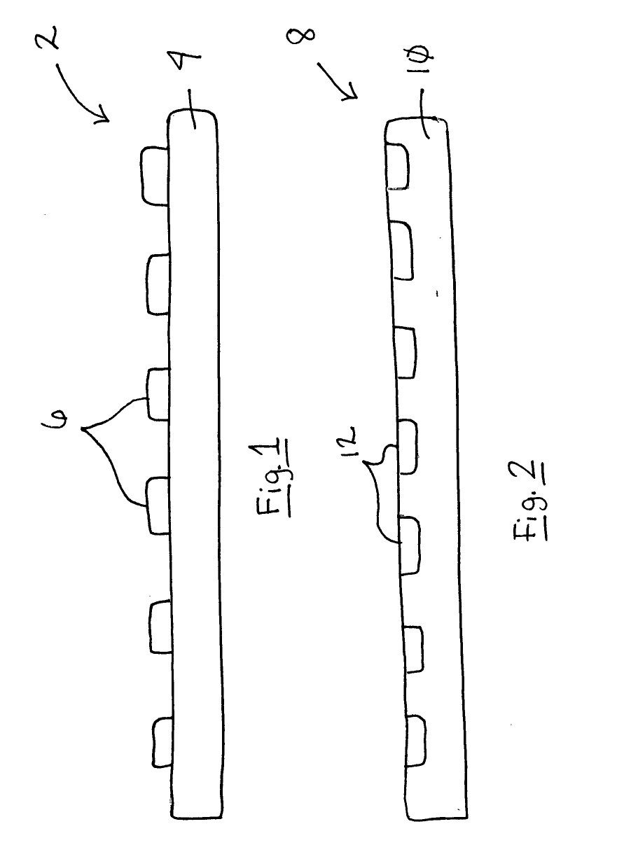

FIG. 2 illustrates another embodiment of the liner/insulator 8. In FIG. 2, ribs 12 are spaced within the base layer 10. During manufacture, the base layer 10 is slit in a plurality of sections and ribs 12 are inserted into the slit sections.

In another embodiment of the present invention, as shown in FIG. 4, ribs cut from a blanket 19 of cubes of fibrous material 15 may form the ribs 16 (FIG. 3). The material and manufacture of the cubed material is referenced in related U.S. patent application Ser. No. 10/749,084, filed Dec. 30, 2003, which is herein incorporated by reference in its entirety.

As shown in FIG. 5, a one or more facings may also be included in the liner/insulator. Liner/insulator 17 includes ribs 22 within base layer 18, as discussed above. A relatively higher density skin 20 is shown along one face thereof. Preferably, the skin 20 has a thickness of between substantially 0.25-10.0 mm and a density of between substantially 32.0-800.0 kg/m³. The density of the skin 20 may be substantially constant throughout its thickness or it may vary gradually lower from a maximum density along the outer face thereof to a density just above that of the base layer 18 along the inner portion thereof. Where the density of the skin 20 varies, the average density for the skin falls within the indicated range. The liner/insulator 17 may not contain the skin 20 or, in the alternative, may contain a first skin 20 and a secondary skin (not shown).

Further, the blanket may include a facing, on one or both sides, to improve strength and/or surface appearance. In applications requiring superior heat insulative characteristics, a facing layer 21 or 23, as shown in FIG. 5, may be formed from a heat reflective material such as a metallic foil (e.g. aluminum or other heat reflective metal). The facing layer may be applied the uniform polymer blanket 16 (FIG. 5) and/or the individual pieces 12 (FIG. 1) may be cut from and uniform polymer blanket having a facing layer 21 or 23. Where a metallic foil is used foil thickness is generally in the range of 0.025-0.25 mm. The thickness selected is based upon the temperature, durability and structural requirements of the particular product application.

The facing layer 21 or 23 may be reinforced or non-reinforced. Reinforcements are included to add durability and structural integrity. Reinforcements may take the form of fibrous scrims, fibrous mats or fibrous webs. For many applications, the reinforcement is made from a relatively strong fiber such as fiberglass. The strands may be materials other than glass which provide the desired properties (e.g. polyester).

Alternative reinforcement materials for the facing layer 21, 23 include but are not limited to glass mats, polymer mats and blended mats. The reinforcement may be pre-attached to the metallic foil. Alternatively loose laid reinforcement may be utilized. In most applications, the foil layer reinforcement provides improved tear resistance, strength and/or acoustical insulating properties. However, in many applications, it should be appreciated that no reinforcement is necessary. While not explicitly shown, it should be appreciated that the edges of the liner/insulator 17 may also be heat-seared in order to enhance water-barrier protection in applications where water-barrier protection is of critical importance.

The facing layer 21 or 23 (reinforced or non-reinforced) is attached to the base layer 18 by means of a heat activated adhesive. The adhesive utilized may be a thermoplastic sheet or thermoplastic web material that tends to melt and flow at temperatures between 200-350° F. Adhesives of this type are desirable because they can be activated during the molding phase of production. Besides thermoplastic sheets and webs, adhesives such as hot melts, latex and various heat-activated resins may be utilized. The adhesive may be a separate layer as illustrated or the adhesive may already be attached to the facing layer 21 or 23.

A number of different techniques may be utilized to manufacture the liner/insulator 2 of the present invention. The liner/insulator 2 may be prepared by differential heating and uniform compression. As a specific example, the liner 2 shown in FIG. 1 is prepared by heating one side of the base layer 4 i.e. the side to include the ribs 6, while the other side remains relatively cool. A pressure is then applied for sufficient time to allow the polymer binding fiber to soften near the hot surface but not near the cold surface. When this occurs under compression, the hot side is reshaped into a higher density layer or skin. The cool side of the polymer binding fiber does not soften and, therefore, when the pressure is removed, it retains most of its original thickness and density characteristics. This technique may be performed in a standard molding press where one platen runs hot and the other runs cool.

In an alternative technique, two polymer binding fibers having significantly different softening points are utilized. In one approach, the base layer 4 and the ribs 6 are produced each utilizing a different softening point polymer fiber. The base layer 4 and ribs 6 are brought together in a molding operation utilizing differential heating and compressed to a given gap width for a given length of time and at a given temperature differential. The component (ribs or base layer) with the lower softening point polymer binding fiber is placed next to the hot platen and the higher softening point component is placed next to the cool platen. When compression occurs, a higher density layer or skin (not shown) is formed from the lower softening point component while the higher temperature layer is unaffected and retains its original density. The base layer and ribs are otherwise fused so as to have an integral construction.

Adhesives may be used as an alternative to or in conjunction with thermal bonding of the ribs 6 and the base layer 4. The adhesive may be any adhesive known in the art including but not limited to solvent-based and water-based adhesives or hot-melt adhesives. A preferable adhesive is polyethyelene.

Additional information respecting the manufacturing of the liners/insulators of the present invention may be gleaned from a review of copending U.S. patent application Ser. No. 09/607,478 filed Jun. 30, 2000, the full disclosure of which is incorporated herein by reference.

The foregoing description of preferred embodiments of the invention has been presented for purposes of illustration and description. It is not intended to be exhaustive or to limit the invention to the precise form disclosed. Obvious modifications or variations are possible in light of the above teachings.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1.) a liner/insulator, comprising:
a base layer of fibrous material;
a plurality of ribs of fibrous material thermally bonded to said base layer.

2.) The liner/insulator of claim 1, wherein said fibrous material is selected from a group consisting of (a) thermoplastic polymer staple fibers and thermoplastic bicomponent fibers, (b) glass staple fibers and glass bicomponent fibers and (c) glass staple fibers and thermoplastic bicomponent fibers and (d) a combination of (a), (b) and (c).

3.) The liner/insulator of claim 1, wherein said fibrous material is selected from a group of materials consisting of polyester, polyethylene, polypropylene, polyethylene terephthalate, glass fibers, natural fibers and any mixtures thereof.

4.) The liner/insulator of claim 1, wherein said plurality of ribs are spaced apart at least about 0.25 inches.

5.) The liner/insulator of claim 1, wherein said plurality of ribs extend parallel to one another.

6.) The liner/insulator of claim 1, wherein said plurality of ribs extend perpendicular to one another.

7.) The liner/insulator of claim 1, wherein said plurality of ribs extend diagonally to one another.

8.) The liner/insulator of claim 1, wherein said plurality of ribs are between about 0.5 to about 3.0 inches wide.

9.) The liner/insulator of claim 2, wherein said liner/insulator has a percent wet compression of between about 15 to about 18 percent.

10.) The liner/insulator of claim 2, wherein said liner/insulator has a percent dry compression of between about 16 to about 21 percent.

11.) The liner/insulator of claim 2, wherein said liner/insulator has a percent dry wet recovery of between about 85 to about 87.5 percent.

12.) The liner/insulator of claim 1, wherein said liner/insulator is an automotive undercarpet.

13.) The liner/insulator of claim 1, wherein said plurality of ribs are made of scrap fibrous material.

14.) The liner/insulator claim 1, wherein said plurality of ribs comprise a lofty, acoustically insulating portion having a density of between substantially 8.0-80.0 kg/m³ and a relatively higher density skin along at least one face thereof, said skin having a thickness of between substantially 0.25-10.0 mm and a density of between substantially 32.0-80.0 kg/m³.

15.) The liner/insulator of claim 1, wherein said liner/insulator is a nonlaminate.

16.) The liner/insulator of claim 1, wherein said liner/insulator further comprises at least one facing layer.

17.) The liner/insulator of claim 16, wherein said facing layer comprises metallic foil, glass mats, polymer mats and blends thereof.

18.) The liner/insulator of claim 1, wherein said blanket further comprises at least one water barrier layer.

19.) A method of producing a liner/insulator comprising the steps of:
a) providing a base layer of fibrous material;
b) providing a plurality of ribs of fibrous insulation material; and
c) thermally bonding said plurality of ribs of fibrous insulation material to said base layer of fibrous material.

20.) The method of claim 19, wherein said fibrous material is selected from a group consisting of (a) thermoplastic polymer staple fibers and thermoplastic bicomponent fibers, (b) glass staple fibers and glass bicomponent fibers and (c) glass staple fibers and thermoplastic bicomponent fibers and (d) a combination of (a), (b) and (c).

21.) The method of claim 19, wherein said fibrous material is selected from a group of materials consisting of polyester, polyethylene, polypropylene, polyethylene terephthalate, glass fibers, natural fibers and any mixtures thereof.

22.) The method of claim 19, wherein said plurality of ribs are spaced apart at least about 0.25 inches.

23.) The method of claim 19, wherein said plurality of ribs extend parallel to one another.

24.) The method of 19, wherein said plurality of ribs extend perpendicular to one another.

25.) The method of claim 19, wherein said plurality of ribs extend diagonally to one another.

26.) The method of claim 19, wherein said plurality of ribs are between about 0.5 to about 3.0 inches wide.

27.) The method of claim 20, wherein said liner/insulator has a percent wet compression of between about 15 to about 18 percent.

28.) The method of claim 20, wherein said liner/insulator has a percent dry compression of between about 16 to about 21 percent.

29.) The method of claim 20, wherein said liner/insulator has a percent dry wet recovery of between about 85 to about 87.5 percent.

30.) The method of claim 19, wherein said liner/insulator is an automotive undercarpet.

31.) The method of claim 19, wherein said plurality of ribs are made of scrap fibrous material.

32.) The method of claim 19, wherein said plurality of ribs comprise a lofty, acoustically insulating portion having a density of between substantially 8.0-80.0 kg/m³ and a relatively higher density skin along at least one face thereof, said skin having a thickness of between substantially 0.25-10.0 mm and a density of between substantially 32.0-80.0 kg/m³.

33.) The method of claim 19, wherein said liner/insulator is a nonlaminate.

34.) The method of claim 19, wherein said liner/insulator further comprises at least one facing layer.

35.) The method of claim 34, wherein said facing layer comprises metallic foil, glass mats, polymer mats and blends thereof.

36.) The method of claim 19, wherein said blanket further comprises at least one water barrier layer.

37.) The method of claim 19, wherein said plurality of ribs are thermally bonded to said base layer at a temperature of between about 200° F. to about 350° F.
